(19) United States
(12) Patent Application Publication
(10) Pub. No.: US 2026/0120413 A1
(43) Pub. Date: Apr. 30, 2026

(54) CONTROL FOR USING INFORMATION PROCESSING APPARATUS EXISTING IN REAL SPACE IN VIRTUAL SPACE

(71) Applicant: RAKUTEN MOBILE, INC., Tokyo (JP)

(72) Inventors: Hitomi SATO, Tokyo (JP); Takashi KATAGIRI, Tokyo (JP)

(73) Assignee: RAKUTEN MOBILE, INC., Tokyo (JP)

(21) Appl. No.: 17/921,377

(22) PCT Filed: Jul. 28, 2022
(86) PCT No.: PCT/JP2022/029101

§ 371 Date: Jan. 16, 2025

(51) Int. Cl. G06T 19/00

(52) U.S. Cl. CPC G06T 19/006

(57) ABSTRACT

An information processing apparatus according to one aspect of the present disclosure includes one or more processors. At least one of the one or more processors executes first display processing, detection processing, and second display processing. In the first display processing, a first image representing a virtual space is displayed while a second image from a communication apparatus is displayed in a predetermined display area. In the detection processing, an operation on the second image displayed in the display area is detected. In the second display processing, a third image to be displayed on the communication apparatus when the operation on the second image is followed is displayed in the display area.

### TECHNICAL FIELD

The present disclosure relates to a technique for using an information processing apparatus that exists in real space, in a virtual space.

### BACKGROUND ART

In recent years, techniques for providing users with all sorts of entertainment such as games and shopping in a virtual space (virtual reality space) have been widely used. It is expected that all services provided in real space will be provided in a virtual space, and it is assumed that due to such a virtual space being constructed, users will spend more time in the virtual space. When users spend a lot of time in a virtual space, there is a possibility that there will be increased demand for the users to use a communication apparatus that they possess in real space for various purposes, such as searching for any service or location in the virtual space or communicating with friends in real space.

Patent Literature Document 1 discloses a technique in which a user wearing a headset having a display function for displaying an image representing a virtual space and an image capture function causes the headset to display image capture data in real space without removing the headset. According to the technique of the document, by displaying a communication apparatus in real space on the headset, the user can use the communication apparatus even in the virtual space.

### LISTING OF REFERENCES

### Patent Literature Documents

Patent Literature Document 1: JP 2021-9647A

### SUMMARY OF THE INVENTION

### Problems to be Solved by the Invention

According to the technique disclosed in the above document, the user can use the communication apparatus in real space while in the virtual space, but in order to do so, the user needs to actually see the communication apparatus in real space via a camera. For this reason, in this technique, there is a restriction that the communication apparatus is kept at hand in order to use the communication apparatus. Also, it is necessary to actually perform an input operation manually while watching the image of the camera on the communication apparatus in the real space, which is inconvenient. Also, this impairs the sense of immersion in the virtual space.

In view of such problems, an object of the present disclosure is to provide a technique for improving the convenience of a user who uses a communication apparatus in real space, in a virtual space.

### Solution to the Problems

In order to solve the above-described problems, an information processing apparatus according to one aspect of the present disclosure includes one or more processors. At least one of the one or more processors executes first display processing, detection processing, and second display processing. In the first display processing, a first image representing a virtual space is displayed while displaying a second image from the communication apparatus in a predetermined display area. In the detection processing, an operation on a predetermined operation area is detected. In the second display processing, a third image to be displayed on the communication apparatus when the communication apparatus follows the operation is displayed in the display area.

In order to solve the above-described problems, a communication system according to one aspect of the present disclosure includes one or more processors. At least one of the one or more processors executes first display processing, detection processing, and second display processing. In the first display processing, a first image representing a virtual space is displayed while a second image from a communication apparatus is displayed in a predetermined display area. In the detection processing, an operation on a predetermined operation area is detected. In the second display process, a third image to be displayed on the communication apparatus when the communication apparatus complies with the operation is displayed in the display area.

In order to solve the above-described problems, an information processing method according to one aspect of the present disclosure includes a first display step, a detection step, and a second display step. In the first display step, a first image representing a virtual space is displayed while a second image from a communication apparatus is displayed in a predetermined display area. In the detection step, an operation on a predetermined operation area is detected. In the second display step, a third image to be displayed on the communication apparatus when the communication apparatus complies with the operation is displayed in the display area.

### Advantageous Effects of the Invention

According to the technique of the present disclosure, it is possible to improve the convenience of a user who uses a communication apparatus in real space, in a virtual space.

### BRIEF DESCRIPTION OF THE DRAWINGS

FIG. 1 shows a configuration example of a communication system according to an embodiment of the present disclosure.

FIG. 2 shows a configuration example of a user terminal according to an embodiment of the present disclosure.

FIG. 3 shows a configuration example of a head mounted display (HMD) according to an embodiment of the present disclosure.

FIG. 4 shows a configuration example of a virtual reality (VR) content distribution system according to an embodiment of the present disclosure.

FIG. 5 shows an example of a screen displayed on a display of a user terminal during remote connection.

FIG. 6 shows an example of a communication sequence diagram for the user terminal, the HMD, and a server apparatus.

FIG. 7 shows another example of a communication sequence diagram for the user terminal, the HMD, and the server apparatus.

FIG. 8A shows an example of a VR image displayed on the HMD.

FIG. 8B shows an example of a VR image for selecting a user terminal mode to be used in a virtual space.

FIG. 8C shows an example of a VR image including an outer frame of the user terminal displayed in the virtual space.

FIG. 8D shows an example of a VR image seen from the HMD.

FIG. 8E shows an example of a VR image including a user terminal displayed in a superimposed manner in a virtual space.

FIG. 8F shows another example of a VR image viewed from the HMD.

### DESCRIPTION OF EMBODIMENTS

Hereinafter, embodiments of the present disclosure will be described in detail with reference to the accompanying drawings. Among the constituent elements disclosed below, those having the same functions are denoted by the same reference numerals, and descriptions thereof are omitted. Note that the embodiment disclosed below is one mode of the present disclosure, should be modified or changed as appropriate according to the configuration of the apparatus and various conditions, and is not limited to only the following embodiment. Moreover, not all combinations of features described in the present embodiment are essential for solving the above problems.

In this embodiment, an example of using a virtual reality (VR) space or a metaverse, which is a mechanism thereof, in which a real user (human) acts as an alter ego called an avatar on the Internet, will be described. In the following description, the term “virtual reality space” (or “virtual space”) means a virtual space, such as a metaverse, in which a user can act as an alter ego of the user.

### Configuration of Communication System

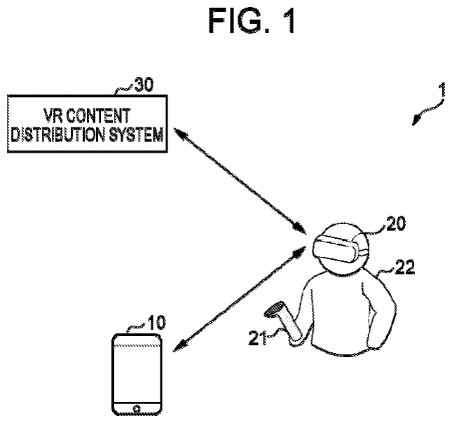

FIG. 1 shows a configuration example of a communication system 1 according to this embodiment. The communication system 1 includes a user terminal 10, a head mounted display (HMD) 20, and a VR content distribution system 30. The HMD 20 is a device that can be worn on the head of the user (player) 22. The HMD 20 outputs VR content that constitutes a virtual space and is distributed by the VR content distribution system 30, and the user 22 can view the VR content. VR content includes at least a VR image (image data forming a virtual space), and may also include audio. Note that in this embodiment, the term “image” is understood to include still images and/or moving images. The user 22 can enjoy the virtual space by viewing the VR content.

The HMD (information processing apparatus) 20 may be of a binocular type or a monocular type. Also, the HMD 20 may be of a non-transmissive type that completely covers the eyes of the user 22, or may be of a transmissive type. The non-transmissive type may provide a more immersive experience. Also, the HMD 20 may be a goggle-type, eyeglass-type, or hat-type of device.

By holding the controller 21 and performing an input operation, the user 22 can perform various controls and settings such as control of the avatar corresponding to the user 22. For example, the user 22 can perform a desired input operation by tilting the controller 21 or pressing a button (not shown) provided on the controller 21. Note that although FIG. 1 shows an example in which the controller 21 is composed of one piece of hardware, the controller 21 may be composed of two controllers, one for the right hand and the other for the left hand. Also, the controller 21 is not limited to a form held by the user 22, and may be in any form as long as the input operation by the user 22 is possible.

The user terminal (communication apparatus) 10 is a device such as a smartphone or a tablet, and has a display (display screen) such as a liquid crystal display (LCD). The touch panel technology enables the user 22 to perform various operations in real space using a GUI (Graphic User Interface) equipped on the liquid crystal display. Note that the user terminal 10 may also be a device such as a tablet terminal or a notebook PC.

The VR content distribution system 30 provides the user 22 with VR content (that is, a virtual space) by transmitting the VR content to the HMD 20. As will be described later, the VR content distribution system 30 is constituted by a server apparatus 31 and a content database 32. The content database 32 includes image data (VR images) representing a virtual space, model data of an avatar that is the alter ego of the user 22, voice data, and the like. The server apparatus 31 uses the data stored in the content database 32 to generate a VR image corresponding to the movement of the HMD 20 and the operation of the controller 21, and transmits the generated VR image to the HMD 20. In addition to the VR image, audio may also be transmitted to the HMD 20 according to the movement of the HMD 20 or the operation by the controller 21. The behavior of the avatar can be controlled by the user 22 operating the controller 21. Note that the behavior of the avatar may also be controlled according to the movement of the HMD 20.

The communication system 1 according to this embodiment is configured such that the user 22 can use the user terminal 10 in real space, in the virtual space provided by the VR content distribution system 30. In other words, the communication system 1 is configured such that the user 22 can use the user terminal 10 via the HMD 20 even while the user 22 is experiencing the virtual space via the HMD 20, and without directly seeing or touching the user terminal 10 existing in real space.

A configuration example of a communication system that realizes such processing, an example configuration of each device (system) that configures the communication system, and an example of a specific processing procedure will be described below.

### Configuration of User Terminal 10

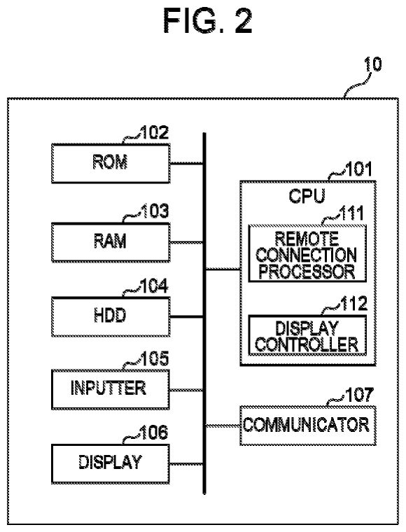

FIG. 2 shows a configuration example of the user terminal 10 according to this embodiment. The user terminal 10 includes a CPU 101, a ROM 102, a RAM 103, an HDD 104, an inputter 105, a display 106, and a communicator 107 as a hardware configuration. The user terminal 10 may also include an external memory. The user terminal 10 also has a remote connection processor 111 and a display controller 112 as functional configurations executed by the CPU 101.

A CPU (Central Processing Unit) 101 is constituted by one or more processors and controls the operation of the user terminal 10 in an integrated manner. The CPU 101 may be replaced by one or more processors such as an ASIC (Application-Specific Integrated Circuit), an FPGA (Field Programmable Gate Array), a DSP (Digital Signal Processor), or a GPU (Graphics Processing Unit). A functional configuration of the CPU 101 will be described later.

The ROM (Read Only Memory) 102 is a non-volatile memory that stores control programs and the like necessary for the CPU 101 to execute processing. Note that the program may be stored in a non-volatile memory such as the HDD (Hard Disk Drive) 104 or an SSD (Solid State Drive) or an external memory such as a removable storage medium (not shown).

The RAM (Random Access Memory) 103 is a volatile memory and functions as a main memory of the CPU 101, a work area, and the like. That is, the CPU 101 loads necessary programs and the like from the ROM 102 to the RAM 103 when executing processing, and realizes various functional operations by executing the programs and the like.

The HDD 104 stores, for example, various types of data, information, and the like necessary for the CPU 101 to perform processing using the program. Also, the HDD 104 stores various types of data, information, and the like obtained by the CPU 101 performing processing using a program or the like, for example. Note that the storage may be performed together with the HDD 104 or instead of the HDD 104 using a non-volatile memory such as an SSD or an external memory such as a removable storage medium.

The inputter 105 is configured to be operable by user 22. In this embodiment, the inputter 105 is equipped as a GUI on the display 106.

The display 106 is constituted by a monitor such as a liquid crystal display. In this embodiment, the display 106 is equipped with a GUI and provides a display screen on which input by the user 22 is possible.

The communicator 107 is an interface that controls communication between the user terminal 10 and an external device. In the present embodiment, the communicator 107 is configured to communicate with the HMD 20 using direct wireless communication (e.g., Bluetooth (registered trademark) or a wireless LAN (wireless Local Area Network conforming to the IEEE 802.11 series)).

Next, the functional configuration of the CPU 101 of the user terminal 10 will be described.

The remote connection processor 111 performs processing for connection for remote operation (hereinafter referred to as remote connection) between the user terminal 10 and the HMD 20. In the present embodiment, the user terminal 10 is the device on the side that receives the remote operation (remote connection destination), and the HMD 20 is the device on the side that performs the remote operation (remote connection source). By installing predetermined software for remote connection in each of the user terminal 10 and the HMD 20, the remote connection processor 111 can execute a function for remote connection provided by the software.

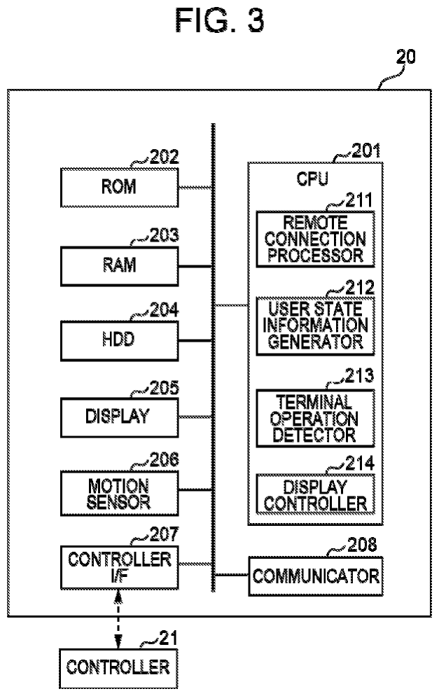

When the remote connection is started, the user terminal 10 starts sending images to the HMD 20. Specifically, at the time of remote connection, the remote connection processor 111 transmits the image data of the screen to the HMD 20 via the communicator 107 so as to cause the display 205 (FIG. 3) of the HMD 20 to display a screen that can be displayed on the display 106 (e.g., an image of an application that is installed in the user terminal 10 and is being operated by the user 22).

Note that the screen does not have to be actually displayed by the display 106. For example, an application may run in the background. Also, for example, while the remote connection processor 111 is transmitting the screen to the HMD 20, the display controller 112 may also perform control such that a screen indicating that remote operation is being performed by another device (remote operation is in progress) is displayed on the display 106 instead of the screen that was originally to be displayed. In this case, the image data of the screen that was originally to be displayed is sent to the HMD 20 instead of the screen indicating that the remote operation is being performed (remote operation is in progress).

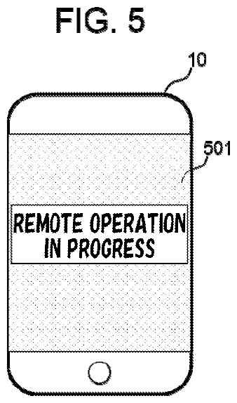

FIG. 5 shows a screen example (image example) displayed on the display 106 of the user terminal 10 during remote connection. By displaying the screen 501 on the display 106 of the user terminal 10, it is shown in real space that the user terminal 10 is in remote connection. As a result, for example, even when a user other than the user 22 looks at the display 106 of the user terminal 10, the other user can recognize that the user terminal 10 is in remote connection (the image data of the screen that was originally to be displayed on the display 106 is being sent to the HMD 20).

The display controller 112 performs display control on the display 106. For example, the display controller 112 displays an image showing information according to the operation performed by the user 22 on the display 106 during normal operation (i.e., when remote connection is not performed). The operations performed by the user 22 include, for example, various operations on content such as images displayed on the screen, such as a tap operation (touch operation), a slide operation, and a scroll operation using a finger, a stylus, or the like. Also, at the time of remote connection, the display controller 112 displays, on the display 106, a screen 501 indicating that remote operation is being performed by another device as shown in FIG. 5, as described above.

### Configuration of HMD 20

FIG. 3 shows a configuration example of the HMD 20 according to this embodiment. The HMD 20 is provided with a CPU 201, a ROM 202, a RAM 203, an HDD 204, a display 205, a motion sensor 206, a controller I/F (interface) 207, and a communicator 208 as a hardware configuration. The HMD 20 may also include an external memory and a line-of-sight detection sensor (a sensor that detects movement of the line of sight of the user 22). The HMD 20 also has a remote connection processor 211, a user state information generator 212, a terminal operation detector 213, and a display controller 214 as functional configurations executed by the CPU 201.

Since the basic configurations of the CPU 201, the ROM 202, the RAM 203, and the HDD 204 are the same as those of the CPU 101, the ROM 102, the RAM 103, and the HDD 104 in FIG. 1, description thereof will be omitted.

The display 205 is realized by a liquid crystal display or the like. For example, the display 205 is provided with a first display (first display region) set in front of the left eye of the user 22 and a second display (second display region) set in front of the right eye, and stereoscopic display is possible. In order to enable such stereoscopic display, the display controller 214 of the CPU 201 can generate a left-eye image and a right-eye image with different parallaxes, display the left-eye image on the first display, and display the right-eye image on the second display. Note that the display 205 may be constituted by an integrated display in which the first display and the second display are integrated.

The motion sensor 206 detects information indicating the orientation of the user 22 wearing the HMD 20, such as the rotation angle and tilt of the HMD 20 (hereinafter referred to as orientation information). The motion sensor 206 can be formed by combining a gyro-sensor, an acceleration sensor, an angular acceleration sensor, and the like.

From the controller 21, the controller I/F 207 detects (receives) information indicating an operation performed by the user on the controller 21 (hereinafter referred to as operation information). For example, the controller I/F 207 receives operation information via the communicator 208. The user's operation on the controller 21 includes, for example, pressing a button provided on the controller 21, the position, orientation, and inclination of the controller 21, and/or the level of force with which the controller 21 is gripped.

Note that in this embodiment, the controller I/F 207 of the HMD 20 is configured to receive operation information from the controller 21, but the controller 21 may also be configured to directly transmit the operation information to the VR content distribution system 30.

The communicator 208 is an interface that controls communication between the HMD 20 and an external device. In the present embodiment, the communicator 208 is configured to communicate with the user terminal 10 using direct wireless communication (e.g., Bluetooth (registered trademark) or wireless LAN (wireless Local Area Network conforming to the IEEE 802.11 series)). The communicator 208 is further configured to communicate with the VR content distribution system 30 via communication networks such as the Internet and a wireless LAN. When communicating with the user terminal 10 and the VR content distribution system 30 using a wireless LAN, the communicator 208 can communicate using different frequency bands.

Next, the functional configuration of the CPU 201 of the HMD 20 will be described.

The remote connection processor 211 performs processing for remote connection between the HMD 20 and the user terminal 10. As described above, in the present embodiment, the user terminal 10 is the device on the side that receives the remote operation (remote connection destination), and the HMD 20 is the device on the side that performs the remote operation (remote connection source). By installing predetermined software for remote connection in each of the user terminal 10 and the HMD 20, the remote connection processor 211 can execute the function for remote connection included in the software.

When remote connection is started, the HMD 20 starts receiving images from the user terminal 10. Specifically, at the time of remote connection, the remote connection processor 211 receives the above-described image data of the screen that can be displayed on the display 106 of the user terminal 10 from the user terminal 10 via the communicator 208. The remote connection processor 211 controls the display controller 211 so as to display the VR image from the VR content distribution system 30 (i.e., the image of the virtual space transmitted from the VR content distribution system 30), while displaying the image from the user terminal 10 in a predetermined display area (the display region). As a result, an image from the user terminal 10, such as the screen of the display 106 of the user terminal 10, is displayed on the display 205. The display controller 211 can continue such processing while continuing the remote connection. For this reason, when an image of a screen that can be displayed on the display 106 of the user device 10 when the user device 10 follows an operation (terminal operation) performed by the user 22 via the HMD 20 or the controller 21 is received from the user terminal 10 via the communicator 208, the image of the screen is displayed on the display 106 by the display controller 211. That is, the display on the display 106 is updated to an image based on the terminal operation.

The user state information generator 211 generates information that does not correspond to the terminal operation out of the orientation information of the user 22 detected by the motion sensor 206 and the operation information of the user 22 detected by the controller I/F 207 as user state information. The user state information generator 211 can transmit the user state information to the VR content distribution system 30 via the communicator 208. If the HMD 20 includes a line-of-sight detection sensor, the user state information can include information on the movement of the line of sight of the user 22.

The terminal operation detector 213 detects information corresponding to the terminal operation (terminal operation information) out of the orientation information of the user 22 detected by the motion sensor 206 and the operation information of the user 22 detected by the controller I/F 207. For example, at the time of remote connection, a predetermined operation performed in a predetermined operation area by the controller 21 corresponds to a terminal operation. Predetermined movements and operations on the HMD 20 and the controller 21 may also be set in advance so as to correspond to terminal operations.

Note that in the user terminal 10, the area for displaying the image and the area for performing the operation do not match in some cases, as with a laptop, and the area for displaying the image and the area for performing the operation match in some cases, as with a touch panel of a smartphone. When the area for displaying the image of the user terminal 10 and the area for performing the operation match, the above-described display area for displaying the image from the user terminal 10 and the operation area for detecting the terminal operation may be matched with each other. Note that they do not have to match completely, and may match at least partially. Note that in the following description, a case where the area for displaying the image of the user terminal 10 and the operation area match each other and the display area and the operation area match each other will be described.

Note that, as will be described later, the positions of the display area and the operation area also differ depending on whether the image from the user terminal 10 is to be displayed as an object in the virtual space or is to be displayed in a superimposed manner in the virtual space.

The display controller 214 performs display control on the display 205. For example, the display controller 214 performs control for displaying, on the display 205, the VR image generated by the VR content distribution system 30 in correspondence with the user state information generated by the user state information generator 211. For example, the display controller 211 performs control for stereoscopic display as described above.

Also, the display controller 214 can display an image imitating the user terminal in a superimposed manner on the VR image while the HMD 20 and the user terminal 10 are remotely connected by the remote connection processor 211. The user terminal represented by the image may imitate the user terminal 10, or may simply imitate a general-purpose user terminal. Also, the display controller 211 sets a display area inside the image imitating the user terminal, and displays the image from the user terminal 10 in the display area under the control of the remote connection processor 211.

### [Configuration of VR Content Distribution System 30]

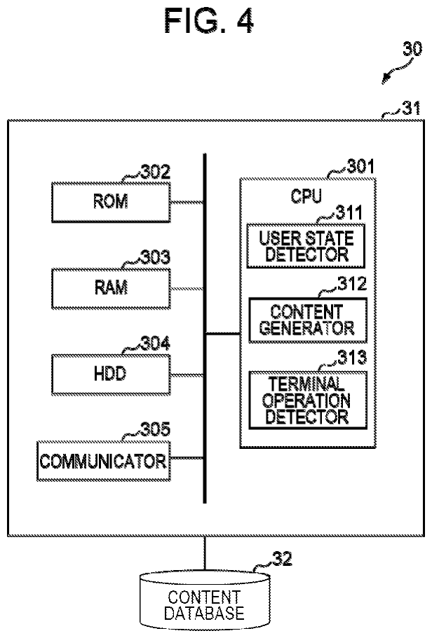

FIG. 4 shows a configuration example of the VR content distribution system 30 according to this embodiment. The VR content distribution system 30 has a server apparatus 31 and a content database 32. Note that the content database 32 may also be included in the server apparatus 31. The VR content distribution system 30 distributes VR content to the HMD 20. If the user 22 needs to perform predetermined login processing (including authentication processing for logging in with a non-general-purpose account) to the VR content distribution system 30 in order to distribute the VR content, the user 22 performs login processing using, for example, predetermined information (e.g., an ID and a password) through operation of the HMD 20 or the controller 21. The login processing can be performed by the server apparatus 31.

The server apparatus 31 includes a CPU 301, a ROM 302, a RAM 303, an HDD 304, and a communicator 305 as hardware configurations. The server apparatus 31 also has a user state detector 311, a content generator 312, and a terminal operation detector 313 as functional configurations executed by the CPU 301. Since the basic configurations of the CPU 301, the ROM 302, the RAM 303, and the HDD 304 are the same as those of the CPU 101, the ROM 102, the RAM 103, and the HDD 104 in FIG. 1, description thereof will be omitted.

The communicator 305 is an interface that controls communication between the server apparatus 31 and an external device. In this embodiment, the communicator 305 is configured to communicate with the HMD 20 via communication networks such as the Internet and a wireless LAN. If the controller 21 is not configured to be able to communicate with the HMD 20, the communicator 305 is configured to communicate with the controller 21 as well.

Next, the functional configuration of the CPU 301 of the server apparatus 31 will be described.

The user state detector 311 detects (receives) the user state information generated and transmitted by the user state information generator 212 of the HMD 20 via the communicator 305 and outputs the user state information to the content generator 312.

The content generator 312 generates VR content from data acquired from the content database 32 based on the user state information detected by the user state detector 311. VR content includes VR images and may also include audio. For example, if the user state information includes a request to use the user terminal, the content generator 312 includes a preset object corresponding to the user terminal in the VR content in the VR image.

The terminal operation detector 313 detects an operation performed by the user 22 on an object corresponding to the user terminal displayed on the HMD 20. The terminal operation detector 313 transmits information (terminal operation information) corresponding to the detected terminal operation to the HMD 20 via the communicator 305. Note that in the present embodiment, the terminal operation information is information corresponding to a predetermined operation performed in a predetermined display area in the virtual space, out of the user state information detected by the user state detector 311.

Note that the user terminal 10, the HMD 20, and the server apparatus 31 may have dedicated hardware for executing their respective functions, or may execute some of their functions by hardware and execute the rest with the computer that runs the program. Also, all functions may be performed by computers and programs.

### Flow of Processing (When Using the User Terminal 10 by Displaying an Image from the User Terminal 10 on an Object in the Virtual Space)

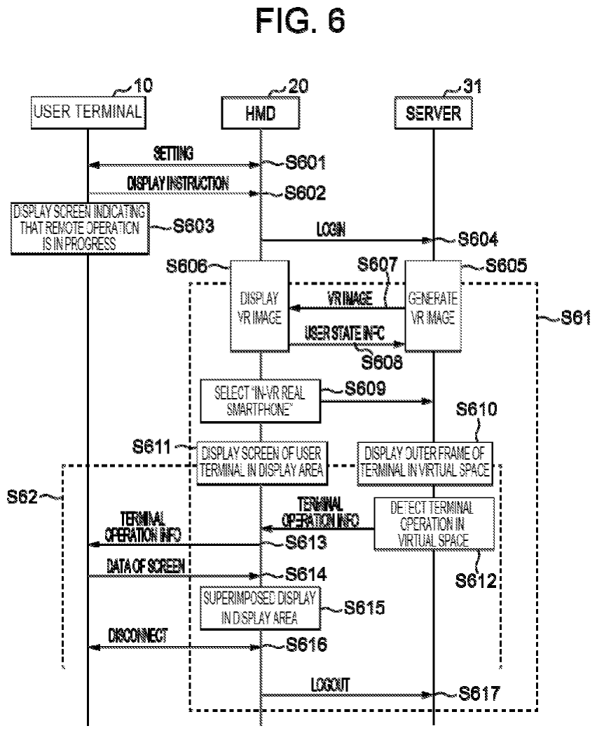

A flow of processing when using the user terminal 10 (operating the user terminal 10) by displaying an image from the user terminal 10 on an object in the virtual space according to the present embodiment will be described with reference to FIG. 6. FIG. 6 shows an example of a communication sequence diagram for the user terminal 10, the HMD 20, and the server apparatus 31 according to this embodiment. It is assumed that predetermined software for remote connection is downloaded and installed in each of the user terminal 10 and the HMD 20 in advance. In the present embodiment, the user terminal 10 is the device on the side that receives the remote operation (remote connection destination), and the HMD 20 is the device on the side that performs the remote operation (remote connection source). Note that it is assumed that authentication information necessary for remote connection, such as the identifier of the remote connection source such as a MAC address, an authentication ID, and an authentication password, is stored in advance in the software. Since remote connection is performed via the software, the user 22 does not need to input the authentication information when starting the remote connection.

In S601, the HMD 20 detects and authenticates a communication apparatus that is a remote connection destination, using pre-stored authentication information via direct wireless communication such as a wireless LAN. As a result, remote connection between the HMD 20 and the user terminal 10 is started. Note that the remote connection may also be performed at a specific timing such as when the HMD 20 is started up. Alternatively, remote connection may be performed based on a predetermined operation from the user 22. After the setting is completed, in S602, the remote connection processor 211 of the HMD 20 instructs the user terminal 10 via the communicator 208 to display a screen indicating that remote operation is being performed by another device, on the display 106. The remote connection processor 111 of the user terminal 10 receives the instruction via the communicator 107, and controls the display controller 112 to display a screen indicating that remote operation is being performed by another device (S603). An example of the screen is as shown in FIG. 5.

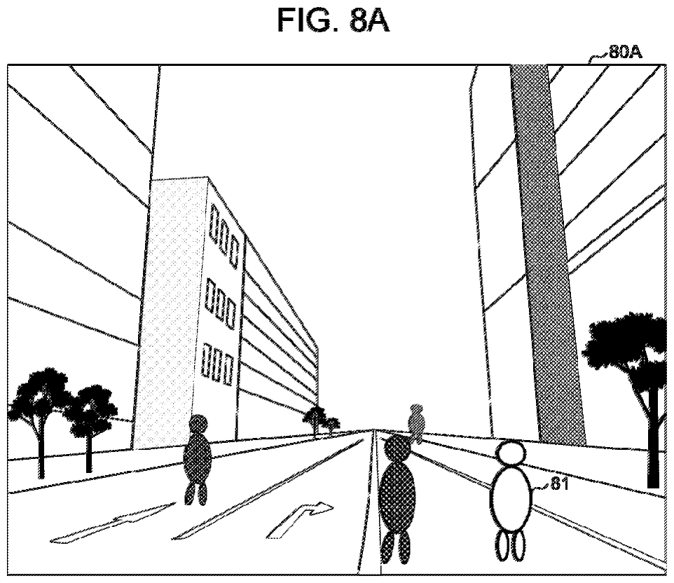

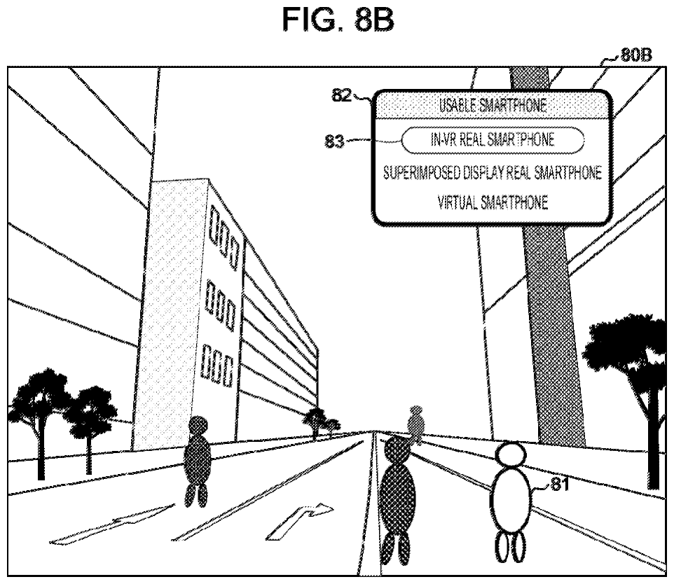

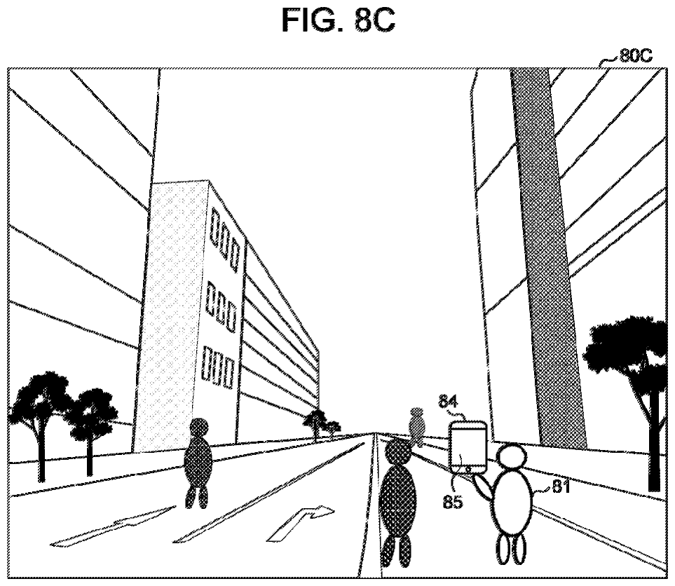

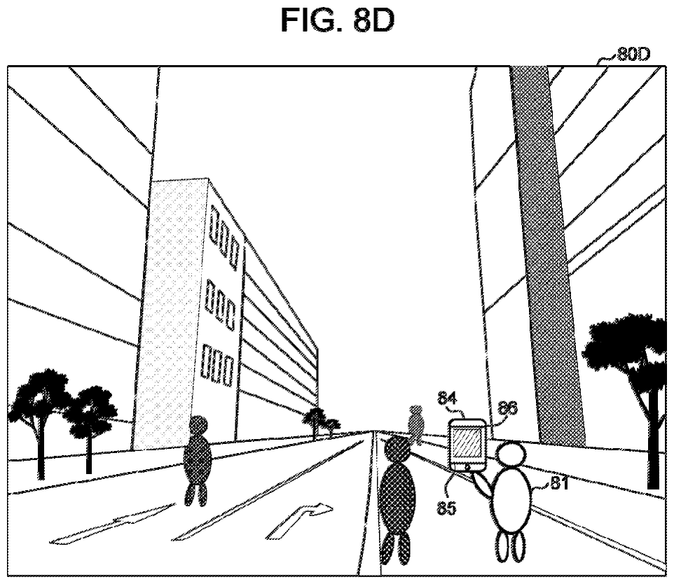

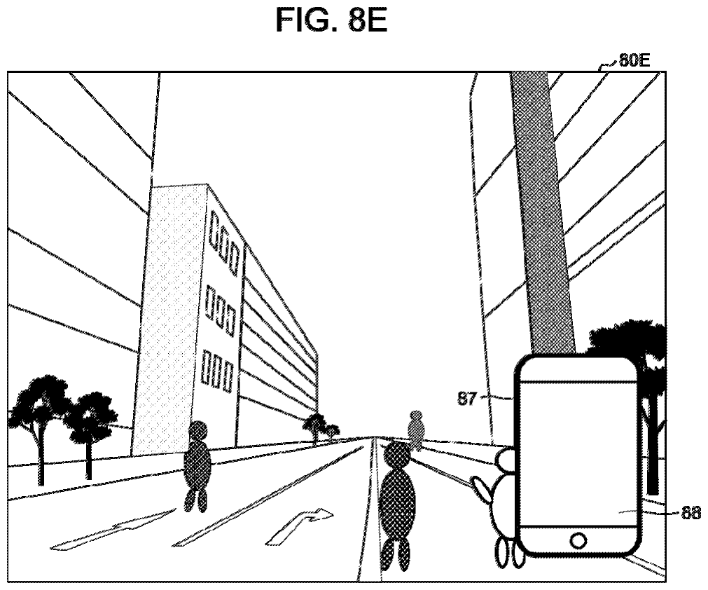

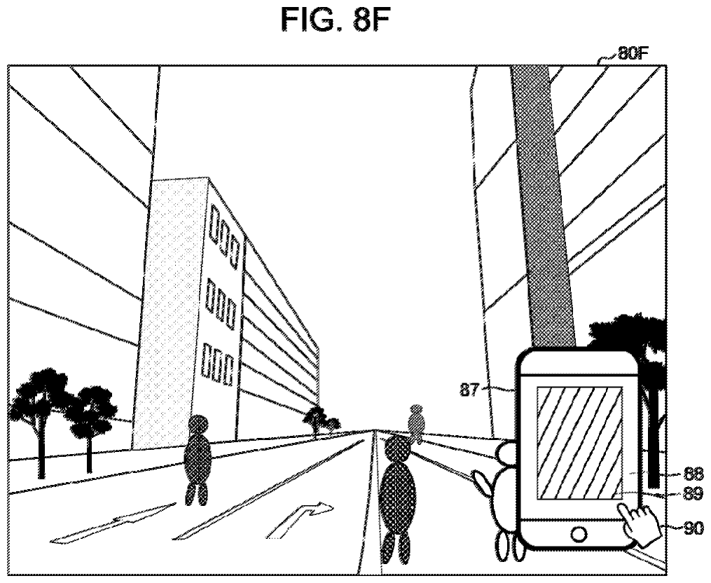

In S604, the HMD 20 logs into the VR content distribution system 30 (the server apparatus 31 in the example of FIG. 6) according to an operation performed by the user 22. When logging in, the user 22 can set an avatar, which is the alter ego of the user 22 to be used in the virtual space. After the HMD 20 logs in, the content generator 312 of the server apparatus 31 generates a VR image (S605) and provides the VR image to the HMD 20 via the communicator 305 (S607). The display controller 214 of the HMD 20 displays the VR image received via the communicator 208 on the display 205 (S606). An example of a VR image is shown in FIG. 8A. An avatar 81 is an avatar corresponding to the user 22 in a VR image 80A in FIG. 8A. Subsequently, the user state information generator 212 of the HMD 20 generates user state information including orientation information of the HMD 20 and operation information of the controller 21, and transmits it to the server apparatus 31 via the communicator 208 (S608). In response to this, the server apparatus 31 generates a VR image according to the user state information (S605) and provides the VR image to the HMD 20 (S607). Such transmission of user state information (orientation information and/or operation information) and provision of VR images continue while the HMD 20 is logged into the system (S61).

After logging into the VR content distribution system 30, the user 22 uses the controller 21 (and/or the HMD 20) to select a user terminal mode to be used in the virtual space. FIG. 8B shows an example of a VR image for selecting a user terminal mode to use in a virtual space. A selection area 82 is displayed in the VR image 80B in FIG. 8B. In the selection area 82, “usable smartphone” refers to a mode of a plurality of user terminals that can be used in the virtual space, and in the present embodiment, it is assumed that 3 types are included, namely “in-VR real smartphone”, “superimposed display real smartphone”, and “virtual smartphone”. Note that “real smartphone” refers to remote operation of the user terminal 10 in the real world of the user 22. On the other hand, “virtual smartphone” is a mode of using a user terminal unrelated to the user terminal 10 displayed in the virtual space by the content distribution system 30, instead of remotely operating the user terminal 10 in the real world of the user 22.

“In-VR real smartphone” is a mode in which the user terminal 10 is used in the virtual space. Specifically, an object corresponding to the user terminal 10 is displayed in the virtual space, and a display area is set for the object. Operation information for the display area is transmitted to the user terminal 10. Note that it is the HMD 20 that displays the image on the object. For this reason, other avatars sharing the virtual space can see nothing displayed on the object.

“Superimposed display real smartphone” is a mode in which the user terminal 10 displayed in a superimposed manner on the virtual space is used. Specifically, the object corresponding to the user terminal 10 does not exist in the virtual space and is displayed independently of the virtual space. For this reason, other avatars sharing the virtual space cannot see the object itself.

“Virtual smartphone” is a mode in which a user terminal other than the user terminal 10 is used in the virtual space. Similar to “in-VR real smartphone”, an object corresponding to the user terminal is displayed in the virtual space, and a display area is set for that object. However, the operation information for the display area is not sent to the user terminal 10, but is sent to the VR content distribution system 30. An image based on the operation information is generated in the VR content distribution system 30, and the image is included as part of the VR image and is transmitted. The HMD 20 simply displays VR images. For this reason, in “virtual smartphone”, the screen of the object can be seen by other avatars sharing the virtual space. It is assumed that “virtual smartphone” is selected when the data and applications of the user terminal 10 do not need to be used. For example, a case is assumed in which an Internet site is browsed with an anonymous account using a general-purpose Web browser, or the like. Note that when “virtual smartphone” is selected, the user terminal 10 is not operated, and therefore description thereof is omitted.

In this example, the user 22 selects “in-VR real smartphone” (mark 83 in FIG. 8B), and the remote connection processor 211 of the HMD 20 notifies the server apparatus 31 that “in-VR real smartphone” has been selected via the communicator 208 (S609).

Upon receiving the notification, the content generator 312 of the server apparatus 31 displays a VR image including an object corresponding to the user terminal 10 in the virtual space (S610). The object corresponds to the in-VR real smartphone, and is a user terminal held by the avatar 81 in the virtual space. The user terminal includes an outer frame and a display area for displaying an image from the user terminal 10. That is, the content generator 312 generates a VR image including an image of the outer frame and the display area of the in-VR real smartphone. The design of the outer frame of the in-VR real smartphone need not be the design of the outer frame of the user terminal 10, and can be the design of the outer frame of a general-purpose user terminal. FIG. 8C shows an example of a VR image including the outer frame of the in-VR real smartphone displayed in the virtual space. In the VR image 80C in FIG. 8C, the outer frame 84 of the in-VR real smartphone possessed by the avatar 81 and the display area 85 within the outer frame 84 are displayed. In the VR image 80C generated by the content generator 312, the display area 85 is blank (i.e., a region where nothing is displayed). Other avatars in the virtual space can also view the outer frame 84 and the display area 85, but to the other avatars, it looks like nothing is displayed in the display area 85.

The remote connection processor 211 of the HMD 20 controls the display controller 214 so as to display an image from the user terminal 10 on the display 205 by remote connection (S611). Specifically, the display controller 214 displays the image from the user terminal 10 in a superimposed manner on the display area inside the outer frame 84 of the in-VR real smartphone displayed in the virtual space. Note that the object in the VR image that is the in-VR real smartphone may also be recognized by receiving metadata indicating information of objects included in the VR image from the content generator 312. Alternatively, the content generator 312 may receive information about the fact that the in-VR real smartphone is included in the VR image, the position of the in-VR real smartphone, and the like from the content generator 312. FIG. 8D shows an example of a VR image viewed from the HMD 20. In the VR image 80D in FIG. 8D, an image from the user terminal 10 is displayed on the terminal possessed by avatar 81. As a result, for the user 22 wearing the HMD 20, a virtual space is provided in which a screen 86 (hatched portion) of the user terminal 10 is displayed in the display area 85 of the outer frame 84 of the user terminal possessed by the avatar 81. Such provision of images from the user terminal 10 in the virtual space continues until the HMD 20 and the user terminal 10 disconnect the remote connection (S62).

Upon detecting a terminal operation in the display area 85, the terminal operation detector 313 of the server apparatus 31 transmits information (terminal operation information) corresponding to the operation to the HMD 20 via the communicator 305 (S612). The operation is, for example, at least one of a tap operation (touch operation), a slide operation, and a scroll operation on the display area 85 by the avatar 81 in the virtual space. The user 22 can see the image from the user terminal 10 on the display 205 of the HMD 20 (see FIG. 8D). For example, when the user 22 operates the avatar 81 with the controller 21 or the like and the avatar 81 taps the display area 85, the tap operation position and the fact that the tap was performed are transmitted to the HMD 20 as terminal operation information.

Upon receiving the terminal operation information via the communicator 208, the remote connection processor 211 of the HMD 20 transmits the terminal operation information to the user terminal 10 via the communicator 208 (S613). Upon receiving the terminal operation information via the communicator 106, the remote connection processor 111 of the user terminal 10 transmits, to the HMD 20 via the communicator 106, the image data of the screen that is to be transitioned to when the operation indicated by the terminal operation information is followed (S614). The remote connection processor 211 of the HMD 20 receives the image data via the communicator 208, and controls the display controller 214 so as to display the image data (i.e., a screen that can be displayed on the display 106 of the user terminal 10) in a superimposed manner on the display area 85 (S615). In this manner, the HMD 20 of the user 22 displays the image from the user terminal 10 on the display area 85 in the virtual space. For this reason, the user 22 can see the image displayed in the display area 85, as with the VR image 80D. However, since the HMDs of the users other than the user 22 do not perform superimposed display with the image of the user terminal 10, for the users other than the user 22, it looks like no image is displayed in the display area 85, as with the VR image 80C.

Thereafter, when the HMD 20 and the user terminal 10 establish a remote connection (S616), the processing of S62 ends.

Also, when the HMD 20 logs out of the VR content distribution system 30 (S617), the server apparatus 31 ends provision of the VR content to the HMD 20, and the processing of S61 ends.

### Flow of Processing (When Using the User Terminal 10 by Displaying an Image from the User Terminal 10 in a Superimposed Manner on the Virtual Space)

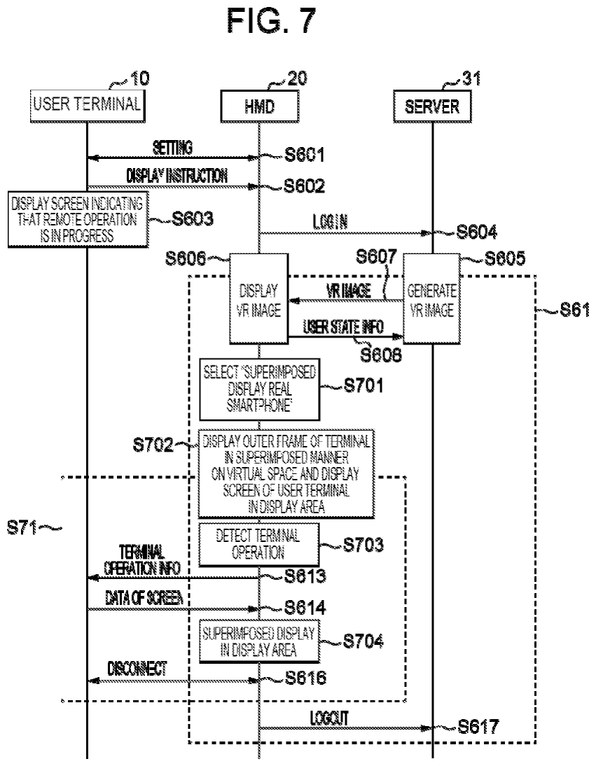

A flow of processing when using the user terminal 10 (operating the user terminal) by displaying a screen that can be displayed on user terminal 10 in a superimposed manner on a virtual space will be described with reference to FIG. 7. FIG. 7 shows another example of a communication sequence diagram of the user terminal 10, the HMD 20, and the server apparatus 31 according to this embodiment. Note that the same processing as in FIG. 6 is denoted by the same reference numerals, and description thereof is omitted.

After logging into the VR content distribution system 30, the user 22 selects the user terminal mode to be used in the virtual space via the controller 21. In this example, “superimposed display real smartphone” is selected in the selection area 82 of the VR image 80B shown in FIG. 8 (S701). According to the selection, the remote connection processor 211 of the HMD 20 controls the display controller 214 so that the display 205 displays an image imitating the outer frame of the user terminal in a superimposed manner on the VR image (that is, the virtual space) (S702). That is, this means that the outer frame is not included in the VR image generated by the content generator 312 of the server apparatus 31, and is displayed by the HMD 20 separately from the VR image.

FIG. 8E shows an example of a VR image including a user terminal displayed in a superimposed manner in the virtual space. In a VR image 80E in FIG. 8E, an outer frame 87 of the user terminal and a display area 88 within the outer frame 87 are displayed. Since the outer frame 87 and the display area 88 do not exist in the virtual space unlike the outer frame 84 and the display area 85 of the VR real smartphone, users other than the user 22 cannot recognize the outer frame 87 and the display area 88. Note that the outer frame 87 can be displayed larger (that is, enlarged) than the outer frame 84 shown in FIG. 8C. The design of the outer frame 87 of the user terminal need not be the design of the outer frame of the user terminal 10, but can be the design of the outer frame of a general-purpose user terminal.

Furthermore, the remote connection processor 211 controls the display controller 214 so as to display an image from the user terminal 10 in the display area 88 (S702). FIG. 8F shows an example of a VR image seen from the HMD 20. In a VR image 80F in FIG. 8F, an image 89 (hatched portion) showing the screen of the user terminal 10 is displayed in the display area 88. Since the outer frame 87 and the display area 88 are displayed larger than the outer frame 84 and the display area 85 in FIG. 8C, the user 22 can see the screen of the user terminal 10 more clearly. Accordingly, screen operation also becomes easier. Such provision of the screen of the user terminal 10 in the virtual space continues until the HMD 20 and the user terminal 10 disconnect the remote connection (S71).

Upon detecting a terminal operation performed by the user 22, the terminal operation detector 213 of the HMD 20 transmits information (terminal operation information) corresponding to the operation to the user terminal 10 via the communicator 208 (S703, S613). The operation is, for example, at least one of a tap operation (touch operation), a slide operation, and a scroll operation on the display area 88. The user 22 can see the image from the user terminal 10 on the display 205 of the HMD 20 (see FIG. 8F). For example, when the user 22 performs a tap operation on the display area 88 with the controller 21 or the like, the tapped position and the fact that the tap was performed are transmitted to the HMD 20 as terminal operation information.

An operation in the display area 88 may be an operation performed by the avatar 81 or an operation performed using a cursor 90 set by the display controller 214. The cursor 90 can be controlled by the controller 21, for example.

Upon receiving the terminal operation information via the communicator 106, the remote connection processor 111 of the user terminal 10 transmits, to the HMD 20 via the communicator 106, the image data of the screen that is to be transitioned to when the operation indicated by the terminal operation information is followed (S614). The remote connection processor 211 of the HMD 20 receives the image data via the communicator 208, and controls the display controller 214 so as to display the image data (the screen of the user terminal 10, etc.) in a superimposed manner on the display area 88 (S704).

Thereafter, when the HMD 20 and the user terminal 10 establish a remote connection (S616), the processing of S71 ends.

Also, due to the HMD 20 logging out of the VR content distribution system 30 (S617), the server apparatus 31 ends provision of the VR content to the HMD 20, and the processing of S61 ends.

As described above, according to the embodiment described above, an image such as the display screen of the user terminal 10 or the original display screen is displayed in the VR image (i.e., the virtual space) displayed on the display 205 of the HMD 20. Furthermore, a screen is displayed on the display 205 according to the operation performed by the user 22 on the display screen. Accordingly, in the virtual space, the user can carry and operate the user terminal owned by the user in real space, and the user can freely use (operate) the user terminal. This improves the convenience of the user who uses the communication apparatus in real space, in the virtual space.

Note that although specific embodiments have been described above, the embodiments are merely examples and are not intended to limit the scope of the present disclosure. The devices and methods described in the present specification can be embodied in modes other than those described above. Also, omissions, substitutions, and modifications may be made as appropriate to the above-described embodiments without departing from the scope of the present disclosure. Such omissions, substitutions, and modifications are included in the scope of the claims and their equivalents, and fall within the technical scope of the present disclosure.

### Embodiments of the Present Disclosure

The present disclosure includes the following embodiments.

[1] An information processing apparatus including one or more processors, in which at least one of the one or more processors executes: first display processing for displaying a first image representing a virtual space while displaying a second image from a communication apparatus in a predetermined display area; detection processing for detecting an operation on a predetermined operation area; and second display processing for displaying, in the display area, a third image to be displayed on the communication apparatus when the communication apparatus follows the operation.

[2] The information processing apparatus according to [1], in which at least one of the one or more processors further executes: authentication processing for detecting and authenticating the communication apparatus using pre-stored authentication information via direct wireless communication; and communication processing for performing reception of an image from the communication apparatus and transmission of the operation to the communication apparatus, via the direct wireless communication.

[3] The information processing apparatus according to [1] or [2], in which at least one of the one or more processors further executes setting processing for setting the display area in an image imitating an outer frame of a communication apparatus shown in the first image.

[4] The information processing apparatus according to [3], in which the display area and the operation area at least partially overlap each other, and the detection processing includes detecting at least one of a tap operation, a slide operation, and a scroll operation on the display area as the operation.

[5] The information processing apparatus according to [1], in which at least one of the one or more processors further executes setting processing for setting the display area in an image imitating an outer frame of a communication apparatus shown in a superimposed manner on the first image.

[6] The information processing apparatus according to [5], in which the display area and the operation area at least partially overlap each other, and the detection processing includes detecting at least one of a tap operation, a slide operation, and a scroll operation on the display area as the operation.

[7] The information processing apparatus according to any one of [1] to [6], in which the communication apparatus is a device that is wearable by the user.

[8] A communication system including one or more processors, in which at least one of the one or more processors executes: first display processing for displaying a first image representing a virtual space, and displaying a second image from a communication apparatus in a predetermined display area; detection processing for detecting an operation on a predetermined operation area; and second display processing for displaying, in a superimposed manner in the display area, a third image to be displayed on the communication apparatus when the communication apparatus follows the operation.

[9] The communication system according to [8], in which at least one of the one or more processors further executes third display processing for displaying an image indicating that a remote operation is being performed, on a screen of the communication apparatus.

[10] An information processing method including: a first display step of displaying a first image representing a virtual space while displaying a second image from a communication apparatus in a predetermined display area; a detection step of detecting an operation on a predetermined operation area; and a second display step of displaying, in the display area, a third image to be displayed on the communication apparatus when the communication apparatus follows the operation.

[11] A computer-readable storage medium storing a program, the program including, when executed by one or more processors of the information processing apparatus, instructions for executing: first display processing for displaying a first image representing a virtual space on an information processing apparatus while displaying, in a predetermined display area, a second image from a communication apparatus; detection processing for detecting an operation on a predetermined operation area; and second display processing for displaying a third image to be displayed on the communication apparatus when the communication apparatus follows the operation, on the display area.

### REFERENCE NUMERALS AND SYMBOLS

10: User terminal
20: Head mounted display (HMD)
21: Controller
22: User
30: VR content distribution system
31: Server apparatus
32: Content database
101: CPU
102: ROM
103: RAM
104: HDD
105: Inputter
106: Display
111: Remote connection processor
112: Display controller
201: CPU
202: ROM
203: RAM
204: HDD
205: Display
206: Motion sensor
207: Controller I/F
208: Communicator
211: Remote connection processor
212: User state information generator
213: Terminal operation detector
214: Display controller
301: CPU
302: ROM
303: RAM
304: HDD
305: Communicator
311; User state detector
312: Content generator
313: Terminal operation detector

1. An information processing apparatus comprising
one or more processors,
wherein at least one of the one or more processors executes:
first display processing for displaying a first image representing a virtual space while displaying a second image from a communication apparatus in a predetermined display area;
detection processing for detecting an operation on a predetermined operation area; and
second display processing for displaying, in the display area, a third image to be displayed on the communication apparatus when the communication apparatus follows the operation.

2. The information processing apparatus according to claim 1,
wherein at least one of the one or more processors further executes:
authentication processing for detecting and authenticating the communication apparatus using pre-stored authentication information via direct wireless communication; and
communication processing for performing reception of an image from the communication apparatus and transmission of the operation to the communication apparatus, via the direct wireless communication.

3. The information processing apparatus according to claim 1,
wherein at least one of the one or more processors further executes
setting processing for setting the display area in an image imitating an outer frame of a communication apparatus shown in the first image.

4. The information processing apparatus according to claim 3,
wherein the display area and the operation area at least partially overlap each other, and
the detection processing includes detecting at least one of a tap operation, a slide operation, and a scroll operation on the display area as the operation.

5. The information processing apparatus according to claim 1,
wherein at least one of the one or more processors further executes
setting processing for setting the display area in an image imitating an outer frame of a communication apparatus shown in a superimposed manner on the first image.

6. The information processing apparatus according to claim 5,
wherein the display area and the operation area at least partially overlap each other, and
the detection processing includes detecting at least one of a tap operation, a slide operation, and a scroll operation on the display area as the operation.

7. The information processing apparatus according to claim 1, wherein the information processing apparatus is a device that is wearable by the user.

8. A communication system comprising
one or more processors,
wherein at least one of the one or more processors executes:
first display processing for displaying a first image representing a virtual space while displaying a second image from a communication apparatus in a predetermined display area;
detection processing for detecting an operation on a predetermined operation area; and
second display processing for displaying, in the display area, a third image to be displayed on the communication apparatus when the communication apparatus follows the operation.

9. The communication system according to claim 8,
wherein at least one of the one or more processors further executes
third display processing for displaying an image indicating that a remote operation is being performed, on a screen of the communication apparatus.

10. An information processing method comprising:
a first display step of displaying a first image representing a virtual space while displaying a second image from a communication apparatus in a predetermined display area;
a detection step of detecting an operation on a predetermined operation area; and
a second display step of displaying, in the display area, a third image to be displayed on the communication apparatus when the communication apparatus follows the operation.
